(19) United States
(12) Patent Application Publication
(10) Pub. No.: US 2026/0106364 A1
(43) Pub. Date: Apr. 16, 2026

(54) APPARATUS, SYSTEM, AND METHOD WITH SUPERCONDUCTING QUANTUM CIRCUIT

(71) Applicant: Samsung Electronics Co., Ltd., Suwon-si (KR)

(72) Inventor: Daeyun KIM, Suwon-si (KR)

(73) Assignee: Samsung Electronics Co., Ltd., Suwon-si (KR)

(21) Appl. No.: 19/056,705

(22) Filed: Feb. 18, 2025

(30) Foreign Application Priority Data
Oct. 15, 2024 (KR) 10-2024-0140545

(51) Int. Cl. H01P 3/00

(52) U.S. Cl. CPC H01P 3/00

(57) ABSTRACT

A superconducting quantum circuit system including a first transducer configured to flow a current pulse and generate a magnon in a transmission line based on the current pulse, a transmission line configured to propagate the generated magnon, and a superconducting quantum device configured to be excited by the propagated magnon.

### CROSS-REFERENCE TO RELATED APPLICATION

This application is based on and claims priority under 35 U.S. C. § 119 to Korean Patent Application No. 10-2024-0140545, filed on Oct. 15, 2024, in the Korean Intellectual Property Office, the entire disclosure of which is incorporated by reference herein in its entirety.

### BACKGROUND

### 1. Field

The disclosure relates to an apparatus, system, and method with a superconducting quantum computer circuit.

### 2. Description of the Related Art

Since the concept of quantum computers was first presented in the late 20th century, various studies have been actively conducted to develop quantum computers. Superconducting quantum computers that utilize the quantum characteristics of superconductors and are considered the most promising approach among various studies to date.

A superconducting quantum computer includes transmission lines for controlling qubits and transmitting quantum information. In general, the transmission lines of superconducting quantum computers include a coplanar waveguide (CPW) structure. In this structure, since the transmission lines share the same ground plane, crosstalk may occur between the transmission lines, which may lead to errors in superconducting quantum computers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a superconducting quantum circuit system including a first transducer configured to flow a current pulse and generate a magnon in a transmission line based on the current pulse, a transmission line configured to propagate the generated magnon, and a superconducting quantum device configured to be excited by the propagated magnon.

The first transducer may be configured to generate a magnetic field corresponding to the current pulse and generate the magnon in the transmission line based on the magnetic field.

The first transducer may be configured to generate the magnon of a transverse spin wave in the transmission line.

The first transducer may be configured in a waveform structure.

The first transducer may be configured in a two-dimensional waveform structure.

The first transducer may be configured in a longitudinal direction of the waveform structure to coincide with a propagation direction of the magnon.

The first transducer may include a superconducting material.

A current pulse frequency of the current pulse may be a microwave band frequency.

The transmission line may be configured to propagate the magnon of a transverse spin wave.

The transmission line may include a magnetic material.

The transmission line may include an insulating material.

The transmission line may be configured to be spaced apart from the superconducting quantum device to not contact the superconducting quantum device.

A magnon frequency of the magnon matches a resonant frequency of the superconducting quantum device.

The superconducting quantum device may be configured to be excited by an energy exchange with the magnon.

The superconducting quantum circuit system may include a second transducer configured to convert the propagated magnon into an electromagnetic wave.

The second transducer may be configured in a waveform structure.

The second transducer may be disposed between the transmission line and the superconducting quantum device.

The superconducting quantum device may be configured to be excited by an energy exchange with the electromagnetic wave.

In a general aspect, here is provided a method including flowing a current pulse through a first transducer of a superconducting quantum circuit system, the superconducting quantum circuit system including the first transducer, a transmission line, and a superconducting quantum device, generating a magnon in the transmission line based on the current pulse of the first transducer, propagating the generated magnon along the transmission line, and exciting the superconducting quantum device by the propagated magnon.

In a general aspect, here is provided a method including flowing a current pulse through a first transducer of a superconducting quantum circuit system, the superconducting quantum circuit system including the first transducer, a transmission line, a second transducer, and a superconducting quantum device, generating a magnon in the transmission line based on the current pulse of the first transducer, propagating the generated magnon along the transmission line, converting, by the second transducer, the propagated magnon into an electromagnetic wave, and exciting the superconducting quantum device based on the electromagnetic wave.

### BRIEF DESCRIPTION OF THE DRAWINGS

FIGS. 1A and 1B illustrate example superconducting quantum circuit apparatuses according to one or more embodiments.

FIG. 2 illustrates an example superconducting quantum circuit system according to one or more embodiments.

FIG. 3 illustrates an example superconducting quantum circuit system according to one or more embodiments.

FIGS. 4A and 4B illustrate example superconducting quantum circuit systems according to one or more embodiments.

FIG. 5 illustrates an example superconducting quantum circuit system according to one or more embodiments.

FIG. 6 illustrates an example superconducting quantum circuit system according to one or more embodiments.

FIG. 7 illustrates example transmission line apparatuses according to one or more embodiments; and

FIG. 8 illustrates an example method with a superconducting quantum circuit system according to one or more embodiments.

FIG. 9 illustrates an example method with a superconducting quantum circuit system according to one or more embodiments.

FIG. 10 illustrates an example electronic device with a superconducting quantum circuit system according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to”may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

The use of the term “may” herein with respect to an example or embodiment, e.g., as to what an example or embodiment may include or implement, means that at least one example or embodiment exists where such a feature is included or implemented, while all examples are not limited thereto.

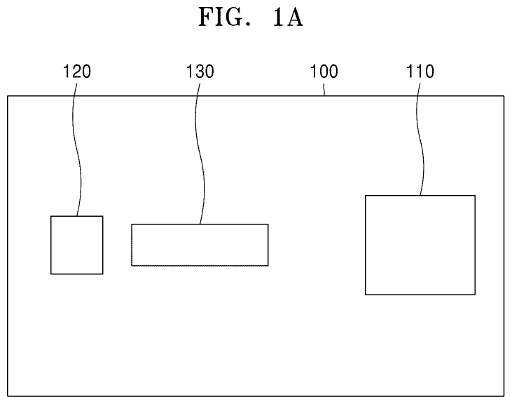

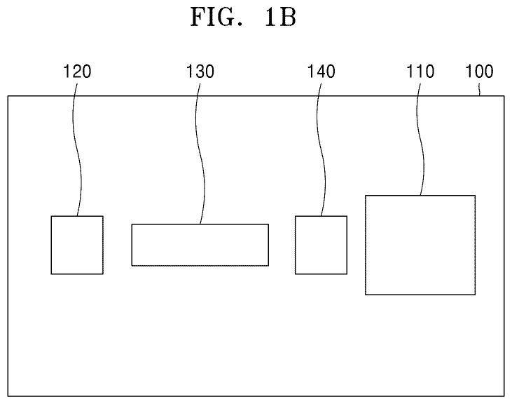

FIGS. 1A and 1B illustrate example superconducting quantum circuit systems according to one or more embodiments.

Referring to FIGS. 1A and 1B, in a non-limiting example, a superconducting quantum circuit system 100 is illustrated. However, a configuration of the superconducting quantum circuit system 100 and an arrangement of components of the superconducting quantum circuit system 100 are not limited to FIGS. 1A and 1B.

The superconducting quantum circuit system 100 may be a system included in a superconducting quantum computer. The superconducting quantum circuit system 100 may include various components for performing quantum computation of a superconducting quantum computer.

Referring to FIG. 1A, in an embodiment, the superconducting quantum circuit system 100 may include one or more of a superconducting quantum device 110, one or more first transducer 120, and one or more transmission line 130.

In an example, the superconducting quantum device 110 may be a device having superposition quantum characteristics. For example, the superconducting quantum device 110 may be a qubit. In an example, the superconducting quantum device 110 may be a device for adjusting the coupling strength between qubits for quantum operation or the like. For example, the superconducting quantum device 110 may be a qubit coupler.

In an example, the superconducting quantum device 110 may be a transmon type. The superconducting quantum device 110 may include superconducting layers and one or more Josephson junctions.

The superconducting layers may include a superconducting material. The superconducting layers may include the same superconducting material or may include different superconducting materials. The superconducting material may include one or more of aluminum (Al), niobium (Nb), indium (In), alpha-tantalum (α-Ta), titanium (Ti), lead (Pb), vanadium (V), or a compound thereof (e.g., NbN, NbTiN, TiN, or VN), but is not limited thereto.

The weak link of the Josephson junction may include, but is not limited to, a ferromagnetic material, a ferrimagnetic material, an anti-ferromagnetic material, or an insulating material.

In an example, the first transducer 120 may be configured to convert an electrical signal into an electromagnetic wave. In an example, a current pulse may be applied to the first transducer 120. The first transducer 120 may be represented as a wire in terms of the current pulse flowing therethrough. When a current pulse flows through the first transducer 120, the first transducer 120 may generate a magnetic field. The first transducer 120 may be represented as an antenna in terms of generating a magnetic field based on a current pulse.

The magnetic field of the first transducer 120 may generate one or more magnons (i.e., one or more spin waves) in the transmission line 130. Spin waves may be excited in the transmission line 130 by the magnetic field of the first transducer 120, and the spin waves may propagate along the transmission line 130.

In an example, the first transducer 120 may generate one or more transverse spin waves. The first transducer 120 may be configured to generate a magnetic field having the same direction as the propagation direction of the spin waves in the plane of the transmission line 130. Since the spin waves may occur in a direction perpendicular to the magnetic field, transverse spin waves may occur in the transmission line 130 by a magnetic field in the same direction as the propagation direction of the spin waves. Magnons of transverse spin waves may propagate along the transmission line 130 with higher energy efficiency compared to the longitudinal spin waves.

The spin waves (i.e., magnons) propagated along the transmission line 130 may excite the superconducting quantum device 110 by coupling the magnons with the superconducting quantum device 110. In detail, the superconducting quantum device 110 may be excited by an energy exchange between the magnons and the superconducting quantum device 110 through the coupling of the magnons with the superconducting quantum device 110. Accordingly, the superconducting quantum device 110 may switch from a ground state to an excited state.

In an example, for strong coupling between magnons and superconducting quantum device 110, the frequency of magnons and the resonant frequency of the superconducting quantum device 110 may match. The matching of the frequency of the magnons and the resonant frequency of the superconducting quantum device 110 may mean that the frequency of the magnons and the resonant frequency of the superconducting quantum device 110 are the same or close enough to allow strong coupling of the magnons and the superconducting quantum device 110.

In an example, the resonant frequency of the superconducting quantum device 110 may be in a GHz range. For strong coupling between magnons and superconducting quantum device 110, magnon frequency may be in a GHz range corresponding to the resonant frequency of superconducting quantum device 110. In addition, in order to excite spin waves in the GHz range, the current pulse may have a frequency in the microwave band.

In an example, the transmission line 130 and the superconducting quantum device 110 may be physically connected to each other. The physical connection may increase the efficiency of energy exchange between magnons and superconducting quantum device 110.

In an example, the transmission line 130 and the superconducting quantum device 110 may not be physically connected to each other. Without physical connection, electromagnetic energy of magnons may be transferred to the superconducting quantum device through radiation. Accordingly, energy transfer may be performed between the magnons and the superconducting quantum device 110.

In an example, the first transducer 120 may include a superconducting material. In addition, the first transducer 120 may be a superconductor. Accordingly, even if the current pulse flows through the first transducer 120, resistance may not occur.

In an example, the transmission line 130 may include a magnetic material. For example, the magnetic material may include a ferromagnetic material, a ferrimagnetic material, or an anti-ferromagnetic material. Further, the transmission line 130 may be ferromagnetic, ferrimagnetic, or anti-ferromagnetic. Accordingly, magnons may be generated in the transmission line 130. In an example, the transmission line 130 may include an insulating material. In addition, the transmission line 130 may be an insulator. For example, the transmission line 130 may include yttrium iron garnet (YIG), but is not limited thereto.

Referring to FIG. 1B, in an example, the superconducting quantum circuit system 100 includes one or more superconducting quantum device 110, one or more first transducer 120, one or more transmission line 130, and one or more second transducer 140. Descriptions that are redundant to those with reference to FIG. 1A are omitted.

The second transducer 140 may be configured to convert magnons into an electromagnetic wave. The second transducer 140 may be disposed between the transmission line 130 and the superconducting quantum device 110. When the magnons propagated along the transmission line 130 reaches the second transducer 140, one or more electromagnetic waves may be generated by spin pumping and/or electromagnetic induction. Furthermore, the superconducting quantum device 110 may be excited by an energy exchange between the generated one or more electromagnetic wave photons and the superconducting quantum device 110.

In an example, the second transducer 140 and the superconducting quantum device 110 may be physically connected to each other. The physical connection may increase the efficiency of the energy exchange between the photons and the superconducting quantum device 110.

In an example, the second transducer 140 and the superconducting quantum device 110 may interact with each other through electromagnetic coupling. Accordingly, the second transducer 140 and the superconducting quantum device 110 may not be physically connected to each other.

In an example, the second transducer 140 may include a superconducting material. In addition, the second transducer 140 may be a superconductor.

In addition to those described with reference to FIGS. 1A and 1B, the superconducting quantum circuit system 100 may further include various components for performing quantum operations of a superconducting quantum computer. For example, the superconducting quantum circuit system 100 may further include devices for measuring a qubit (i.e., a superconducting quantum device 110).

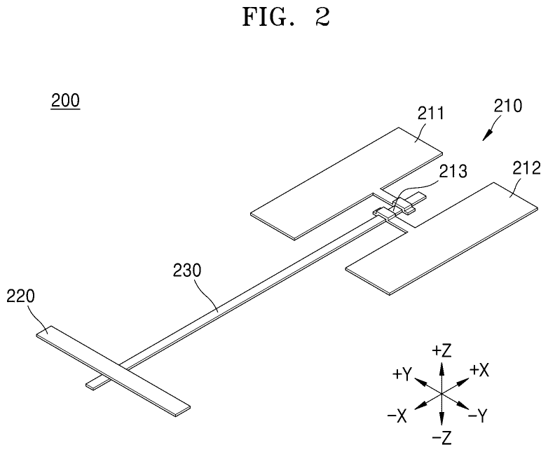

FIG. 2 illustrates an example superconducting quantum circuit system according to one or more embodiments.

Referring to FIG. 2, in a non-limiting example, a superconducting quantum circuit system 200 may include a superconducting quantum device 210, a first transducer 220, and a transmission line 230. The superconducting quantum device 210 may include first and second superconducting layers 211 and 212 and a Josephson junction 213.

In an example, the superconducting quantum device 210, the first transducer 220, and the transmission line 230 may be disposed on the XY plane. The planar arrangement structure may facilitate the design and production of the superconducting quantum circuit system 200.

The first transducer 220 may extend in the Y-axis direction. Accordingly, a current pulse may flow through the first transducer 220 in the +Y-axis or −Y-axis direction.

The transmission line 230 may extend in the X-axis direction. Accordingly, the magnons generated by the first transducer 220 may be propagated along the transmission line 230 in the +X-axis direction.

In an example, the transmission line 230 may be disposed on a layer different from that of the first transducer 220 on the XY plane. For example, the transmission line 230 may be disposed on an upper portion (+Z-axis direction) or a lower portion (−Z-axis direction) of the first transducer 220.

In an example, the transmission line 230 may be physically connected to the superconducting quantum device 210. For example, the transmission line 230 may constitute the Josephson junction 213. Alternatively, the transmission line 230 may be disposed to be connected to the Josephson junction 213. In another example, the transmission line 230 may be disposed to be connected to one of the first superconducting layer 211 or the second superconducting layer 212.

In an example, the transmission line 230 may not be physically connected to the superconducting quantum device 210. For example, the transmission line 230 may extend toward the superconducting quantum device 210 and may be arranged to be spaced apart from the superconducting quantum device 210 so as to not contact the superconducting quantum device 210.

When a current pulse flows through the first transducer 220, a magnetic field may be formed in the plane of the transmission line 230 by electromagnetic induction. As the magnetic pulse excites the spin waves of the transmission line 230, the spin waves (i.e., magnons) may propagate along the transmission line 230. The magnons propagated through the transmission line 230 may be coupled to the superconducting quantum device 210. The superconducting quantum device 210 may be excited by an interaction between magnons and the superconducting quantum device 210.

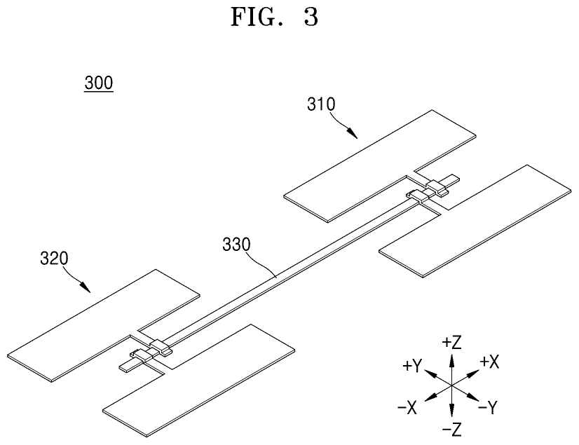

FIG. 3 illustrates an example superconducting quantum circuit system according to one or more embodiments.

Referring to FIG. 3, in a non-limiting example, a superconducting quantum circuit system 300 may include a first superconducting quantum device 310, a second superconducting quantum device 320, and a transmission line 330.

Magnon propagation of the transmission line 330 may be used for transferring quantum information or energy exchange between the first superconducting quantum device 310 and the second superconducting quantum device 320. For example, if the first superconducting quantum device 310 and the second superconducting quantum device 320 are superconducting qubits, the magnons propagation of the transmission line 330 may enable the transfer of quantum information or energy exchange between the qubits.

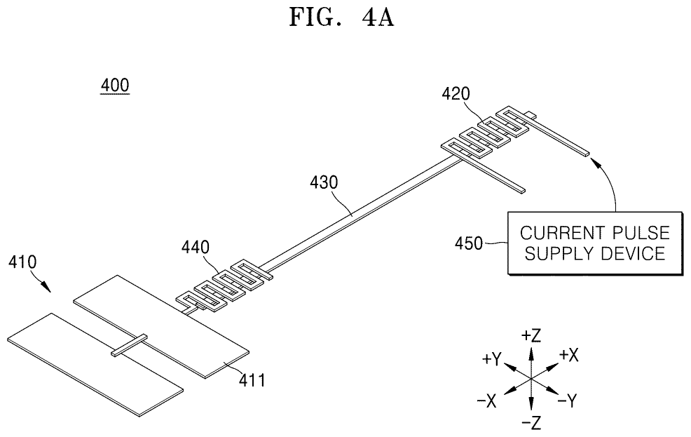

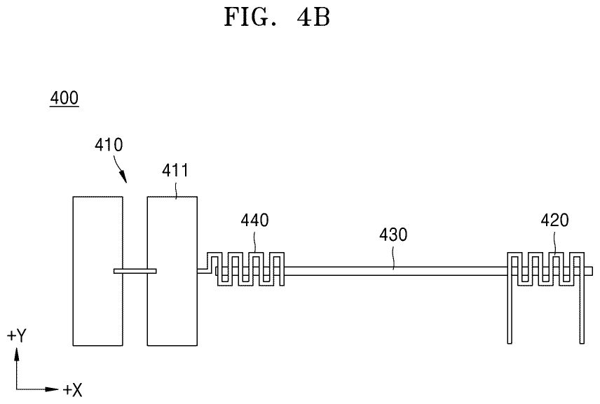

FIGS. 4A and 4B illustrate example superconducting quantum circuit systems according to one or more embodiments.

Referring to FIGS. 4A and 4B, in non-limiting examples, a superconducting quantum circuit system 400 may include a superconducting quantum device 410, a first transducer 420, a transmission line 430, a second transducer 440, and a current pulse supply device 450.

In an example, the superconducting quantum device 410, the first transducer 420, the transmission line 430, and the second transducer 440 may be disposed on the XY plane. The planar arrangement structure may facilitate the design and production of the superconducting quantum circuit system 400.

The first and second transducers 420 and 440 may have a waveform structure. In other words, the shapes of the first and second transducers 420 and 440 may be in a waveform structure, shape, or form. For example, the first and second transducers 420 and 440 may have a square wave or rectangular wave structure, but are not limited thereto. The first and second transducers 420 and 440 may have the same waveform structure or different waveform structures. The first and second transducers 420 and 440 may have a two-dimensional waveform structure. Thus, in an example, the shapes of the first and second transducers 420 and 440 on the XY plane may have a waveform structure. Accordingly, the superconducting quantum circuit system 400 may be designed and produced in a layered structure. In another example, one or more of the first and second transducers 420 and 440 may have a three-dimensional waveform structure such as a spiral structure. In FIGS. 4A and 4B, the first and second transducers 420 and 440 may have a pattern shape sequentially extending in the +X-axis direction, extending in the +Y-axis direction, extending in the +X-axis direction, and extending in the −Y-axis direction.

The first and second transducers 420 and 440 may be arranged such that the longitudinal direction (X-axis direction) of the waveform structure coincides with the propagation direction (X-axis direction) of the magnons of the transmission line 430. In other words, the first and second transducers 420 and 440 may be arranged such that the longitudinal direction (X-axis direction) of the waveform structure coincides with the longitudinal direction (X-axis direction) of the transmission line 430.

The second transducer 440 may be disposed to be physically connected to the superconducting quantum device 410. For example, the second transducer 440 may be connected to the superconducting layer 411 of the superconducting quantum device 410. The second transducer 440 may be disposed on the same layer as the superconducting quantum device 410 in the XY plane, or may be disposed on an upper portion (+Z-axis direction) or a lower portion (−Z-axis direction) of the superconducting quantum device 410.

One end of the transmission line 430 may be connected to a current pulse supply device through the first transducer 420. The current pulse supply device 450 may be a device that supplies a current pulse to the first transducer 420. The other end of the transmission line 430 may be connected to the superconducting quantum device 410 through the second transducer 440.

The transmission line 430 may be disposed to propagate magnons between the first and second transducers 420 and 440. The transmission line 430 may be disposed on a different layer from the first and second transducers 420 and 440 in the XY plane. For example, the transmission line 430 may be disposed on an upper portion (+Z-axis direction) or a lower portion (−Z-axis direction) of the first transducer 420. In addition, the transmission line 430 may be disposed on the upper portion (+Z-axis direction) or the lower portion (−Z-axis direction) of the second transducer 440. In an example, the transmission line 430 may contact one or both of the first and second transducers 420 and 440.

A current pulse may flow along the waveform structure of the first transducer 420. When a current pulse flows through the first transducer 420, a magnetic field may be formed in the plane of the transmission line 430 by electromagnetic induction. In this case, due to the waveform structure of the first transducer 420, a magnetic field in the X-axis direction may be formed in the plane of the transmission line 430. Transverse spin waves may be excited in the transmission line 430 by a magnetic field in the X-axis direction. The transverse spin waves (i.e., magnons) may propagate along the transmission line 430 in the +X-axis direction.

The second transducer 440 may convert the magnons into electromagnetic waves by spin pumping and/or electromagnetic induction between the magnons of the transmission line 430 and the superconducting quantum device 410. The superconducting quantum device 410 may be excited by energy exchange between photons of electromagnetic waves of the second transducer 440 and the superconducting quantum device 410.

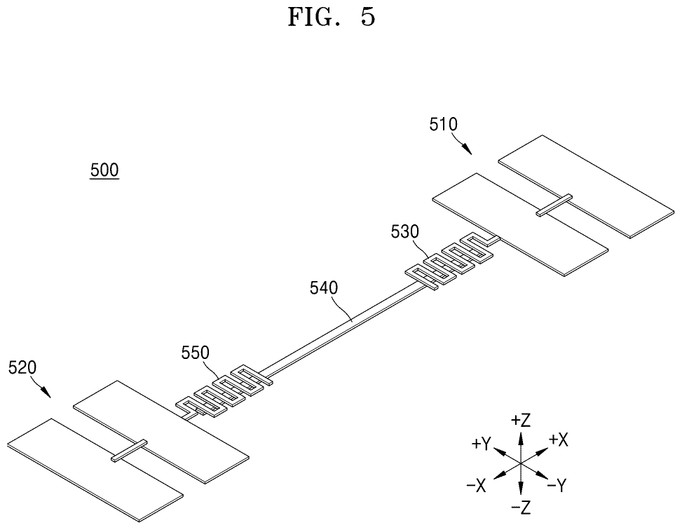

FIG. 5 illustrates an example superconducting quantum circuit system according to one or more embodiments.

Referring to FIG. 5, in a non-limiting example, a superconducting quantum circuit system 500 may include a first superconducting quantum device 510, a second superconducting quantum device 520, a first transducer 530, a transmission line 540, and a second transducer 550.

Magnon propagation of the transmission line 540 and energy conversion of the first and second transducers 530 and 550 may be used for transfer of quantum information or energy exchange between the first superconducting quantum device 510 and the second superconducting quantum device 520. For example, if the first superconducting quantum device 510 and the second superconducting quantum device 520 are superconducting qubits, the magnons propagation of the transmission line 540 and the energy conversion of the first and second transducers 530 and 550 can enable the transfer of quantum information or energy exchange between the qubits.

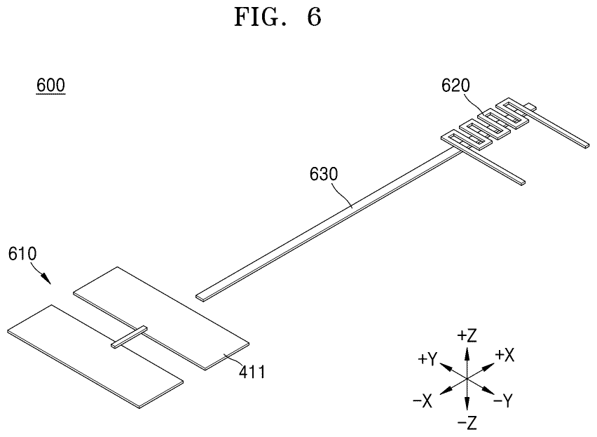

FIG. 6 illustrates an example superconducting quantum circuit system according to one or more embodiments.

The descriptions referring to FIGS. 2, 4A, and 4B may be also applied to FIG. 6. Descriptions redundant with those regarding FIGS. 2, 4A and 4B are omitted.

Referring to FIG. 6, in a non-limiting example, a superconducting quantum circuit system 600 may include a superconducting quantum device 610, a first transducer 620, and a transmission line 630.

The transmission line 630 may be disposed to be spaced apart from the superconducting quantum device 610. For example, the distance between the transmission line 630 and the superconducting quantum device 610 may be within a range in which the coupling between the magnons of the transmission line 630 and the superconducting quantum device 610 which was determined to be a distance at which the coupling may be maintained.

In an example, the transmission line 630 may be disposed on the same layer as the superconducting quantum device 610 in the XY plane.

In an example, the transmission line 630 may extend to have an end facing the superconducting quantum device 610. For example, the transmission line 630 may extend toward the superconducting layer or Josephson junction of the superconducting quantum device 610.

When a current pulse flows through the first transducer 620, a magnetic field in the X-axis direction may be formed in the plane of the transmission line 630 by electromagnetic induction. Transverse spin waves may be excited in the transmission line 630 by a magnetic field in the X-axis direction. The transverse spin waves may propagate along the transmission line 630 in the −X-axis direction.

Since the electromagnetic energy of magnons is transferred to the superconducting quantum device 610 through radiation, energy transfer may be performed between the magnons and the superconducting quantum device 610.

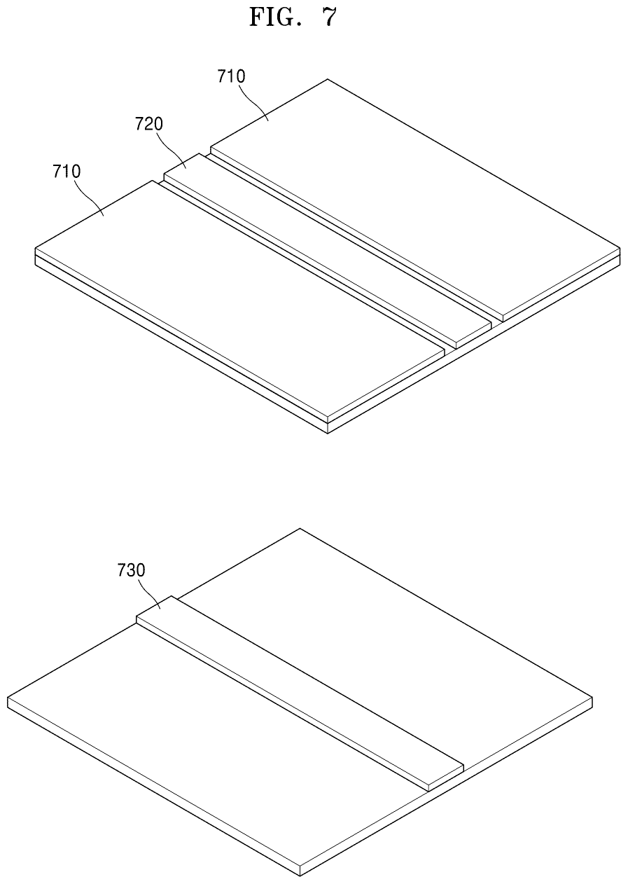

FIG. 7 illustrates example transmission line systems according to one or more embodiments.

Referring to FIG. 7, in a non-limiting example, diagrams for comparing a conventional transmission line 720 with a transmission line 730 of the inventive concept are illustrated.

Typically, a transmission line 720 having a CPW structure was used to drive a qubit. The conventional transmission line 720 necessarily requires a ground plane 710 and shares the ground plane 710 with other transmission lines. As a result, crosstalk typically occurs between the transmission and errors occur in the superconducting quantum computer.

Meanwhile, in an example, the transmission line 730 may be configured to propagate magnons which does not require a ground plane. Therefore, crosstalk due to sharing of the ground plane between the transmission lines does not occur, and errors in superconducting quantum computers due to crosstalk between the transmission lines may be prevented.

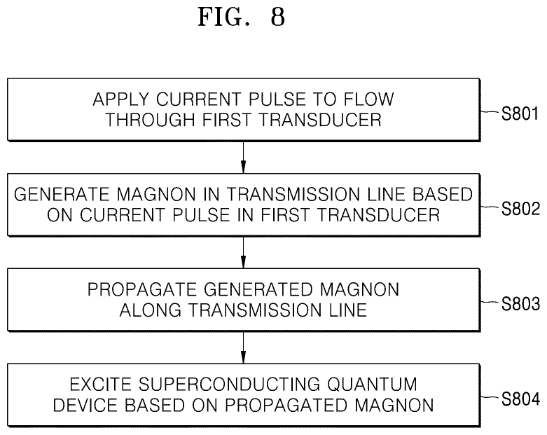

FIG. 8 illustrates an example method with a superconducting quantum circuit system according to one or more embodiments.

Referring to FIG. 8, in a non-limiting example, a superconducting quantum circuit system may include a first transducer (e.g., first transducer 220), a transmission line (e.g., transmission line 230), and a superconducting quantum device (e.g., superconducting quantum device 210).

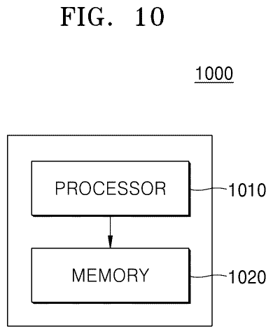

In an example, in operation S801, a current pulse may be applied to and flows through the first transducer. The first transducer may receive a current pulse from a current pulse supply device (e.g., current pulse supply device 450). The current pulse supply device may be controlled by an electronic device (e.g., electronic device 1000 of FIG. 10). The current pulse may have a frequency corresponding to the resonant frequency of the superconducting quantum device. For example, when the resonant frequency of the superconducting quantum device is in the GHz band, the current pulse may have a frequency in the microwave band.

In an example, in operation S802, one or more magnons are generated in the transmission line based on the current pulse of the first transducer. When a current pulse flows through the first transducer, a magnetic field may be formed in the transmission line by electromagnetic induction. The magnetic field may excite one or more spin waves (i.e., one or more magnons) in the transmission line. In an example, for high transmission efficiency of magnons, the first transducer may generate transverse spin waves in the transmission line.

In an example, in operation S803, the generated magnons are propagated along the transmission line. One or more magnons generated by the current pulse of the first transducer may be propagated along the transmission line. Since the transmission line propagates magnons, the transmission line may not require a ground plane.

In an example, in operation S804, the superconducting quantum device is excited based on the propagated one or more magnons. The superconducting quantum device may be excited by an energy exchange between the one or more magnons and the superconducting quantum device by the coupling of the magnons with the superconducting quantum device.

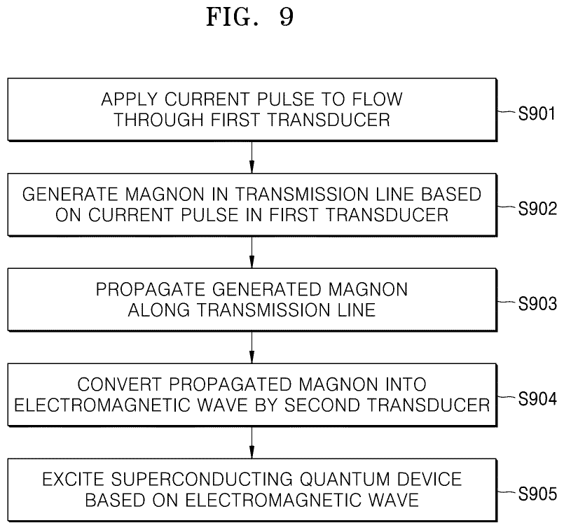

FIG. 9 illustrates an example method with a superconducting quantum circuit system according to one or more embodiments.

The description referring to FIG. 8 may be applied to FIG. 9. Descriptions that are redundant to those with reference to FIG. 8 are omitted.

Referring to FIG. 9, in a non-limiting example, a superconducting quantum circuit system may include first and second transducers (e.g., first transducer 420 and second transducer 440), a transmission line (e.g., transmission line 430), and a superconducting quantum device (e.g., quantum device 410).

In an example, in operation S901, a current pulse may be applied to and flows through the first transducer. For example, a current pulse supply device (e.g., current pulse supply device 450) may supply the current pulse. The current pulse supply device may be controlled by an electronic device (e.g., electronic device 1000).

In an example, in operation S902, one or more magnons are generated in the transmission line based on the current pulse of the first transducer.

In an example, in operation S903, the generated magnons are propagated along the transmission line.

In an example, in operation S904, the second transducer may convert the propagated one or more magnons into one or more electromagnetic waves. When the magnons reach the second transducer, the second transducer may generate electromagnetic waves based on spin pumping and/or electromagnetic induction.

In an example, in operation S905, the superconducting quantum device is excited based on the one or more electromagnetic waves. The superconducting quantum device may be excited by an energy exchange between the one or more photons and the superconducting quantum device by the coupling of the electromagnetic wave photons with the superconducting quantum device.

The methods with a superconducting quantum circuit system as described above with reference to FIGS. 8 and 9 may be used to drive/couple qubits or qubit couplers. The superconducting quantum device may be qubits or qubit couplers, and the transmission line may be a driving line for driving/coupling the qubits or qubit couplers. Magnons propagated through the transmission line may be used to control the state of the qubits or qubit couplers, such as initializing the qubits or qubit couplers or transitioning the state.

FIG. 10 illustrates an example electronic device with a superconducting quantum circuit system according to one or more embodiments.

Referring to FIG. 10, in a non-limiting example, an electronic device 1000 may control a superconducting quantum circuit system, and the electronic device 1000 may include a processor 1010 and a memory 1020. The processor 1010 may be one or more processors or processing elements. In an example, the processor 1010 may control a control transducers (e.g., first transducer 420 and/or second transducer 440) and/or a current pulse supply device (e.g., current pulse supply device 450) of a quantum device or superconducting quantum circuit system (e.g., quantum device 410).

The processor 1010 may be configured to execute programs or applications to configure the processor 1010 to control the electronic apparatus 1000 to perform one or more or all operations and/or methods involving the control of a superconducting quantum circuit system including the current pulse supply device, and may include any one or a combination of two or more of, for example, a central processing unit (CPU), a graphic processing unit (GPU), a neural processing unit (NPU) and tensor processing units (TPUs), but is not limited to the above-described examples.

The memory 1020 may include computer-readable instructions. The processor 1010 may be configured to execute computer-readable instructions, such as those stored in the memory 1020, and through execution of the computer-readable instructions, the processor 1010 is configured to perform one or more, or any combination, of the operations and/or methods described herein. The memory 1020 may be a volatile or nonvolatile memory.

The superconducting quantum circuit systems, electronic devices, memories, processors, current pulse supply devices, Josephson junctions, superconducting quantum circuit system 100, superconducting quantum device 110, first transducers 120, transmission line 130, superconducting quantum circuit system 200, superconducting quantum device 210, first transducer 220, transmission line 230, Josephson junction 213, superconducting quantum circuit system 300, first superconducting quantum device 310, second superconducting quantum device 320, transmission line 330, superconducting quantum circuit system 400, superconducting quantum device 410, first transducer 420, transmission line 430, and second transducer 440, current pulse supply device 450, superconducting quantum circuit system 500, first superconducting quantum device 510, second superconducting quantum device 520, first transducer 530, transmission line 540, second transducer 550, superconducting quantum circuit system 600, superconducting quantum device 610, first transducer 620, and transmission line 630, transmission line 730, electronic device 1000, processor 1010, and memory 1020 described herein and disclosed herein described with respect to FIGS. 1-10 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A superconducting quantum circuit system, comprising:
a first transducer configured to flow a current pulse and generate a magnon in a transmission line based on the current pulse;
a transmission line configured to propagate the generated magnon; and
a superconducting quantum device configured to be excited by the propagated magnon.

2. The superconducting quantum circuit system of claim 1, wherein the first transducer is configured to generate a magnetic field corresponding to the current pulse and generate the magnon in the transmission line based on the magnetic field.

3. The superconducting quantum circuit system of claim 2, wherein the first transducer is configured to generate the magnon of a transverse spin wave in the transmission line.

4. The superconducting quantum circuit system of claim 1, wherein the first transducer is configured in a waveform structure.

5. The superconducting quantum circuit system of claim 4, wherein the first transducer is configured in a two-dimensional waveform structure.

6. The superconducting quantum circuit system of claim 4, wherein the first transducer is configured in a longitudinal direction of the waveform structure to coincide with a propagation direction of the magnon.

7. The superconducting quantum circuit system of claim 1, wherein the first transducer comprises a superconducting material.

8. The superconducting quantum circuit system of claim 1, wherein a current pulse frequency of the current pulse is a microwave band frequency.

9. The superconducting quantum circuit system of claim 1, wherein the transmission line is configured to propagate the magnon of a transverse spin wave.

10. The superconducting quantum circuit system of claim 1, wherein the transmission line comprises a magnetic material.

11. The superconducting quantum circuit system of claim 1, wherein the transmission line comprises an insulating material.

12. The superconducting quantum circuit system of claim 1, wherein the transmission line is configured to be spaced apart from the superconducting quantum device to not contact the superconducting quantum device.

13. The superconducting quantum circuit system of claim 1, wherein a magnon frequency of the magnon matches a resonant frequency of the superconducting quantum device.

14. The superconducting quantum circuit system of claim 1, wherein the superconducting quantum device is configured to be excited by an energy exchange with the magnon.

15. The superconducting quantum circuit system of claim 1, further comprising a second transducer configured to convert the propagated magnon into an electromagnetic wave.

16. The superconducting quantum circuit system of claim 15, wherein the second transducer is configured in a waveform structure.

17. The superconducting quantum circuit system of claim 15, wherein the second transducer is disposed between the transmission line and the superconducting quantum device.

18. The superconducting quantum circuit system of claim 15, wherein the superconducting quantum device is configured to be excited by an energy exchange with the electromagnetic wave.

19. A method, the method comprising:
flowing a current pulse through a first transducer of a superconducting quantum circuit system, the superconducting quantum circuit system comprising:
the first transducer;
a transmission line; and
a superconducting quantum device;
generating a magnon in the transmission line based on the current pulse of the first transducer;
propagating the generated magnon along the transmission line; and
exciting the superconducting quantum device by the propagated magnon.

20. A method, the method comprising:
flowing a current pulse through a first transducer of a superconducting quantum circuit system, the superconducting quantum circuit system comprising:
the first transducer;
a transmission line;
a second transducer; and
a superconducting quantum device;
generating a magnon in the transmission line based on the current pulse of the first transducer;
propagating the generated magnon along the transmission line;
converting, by the second transducer, the propagated magnon into an electromagnetic wave; and
exciting the superconducting quantum device based on the electromagnetic wave.
